(19) United States
(12) Patent Application Publication
(10) Pub. No.: US 2025/0046779 A1
(43) Pub. Date: Feb. 6, 2025

(54) MANUFACTURING METHOD FOR BATTERY MATERIAL

(71) Applicants: Prime Planet Energy & Solutions, Inc., Tokyo (JP); THE UNIVERSITY OF TOKYO, Tokyo (JP)

(72) Inventors: Shinya SUZUKI, Kobe-shi (JP); Takanari OUCHI, Tokyo (JP)

(21) Appl. No.: 18/784,928

(22) Filed: Jul. 26, 2024

(30) Foreign Application Priority Data
Aug. 3, 2023 (JP) 2023-126803

(51) Int. Cl. H01M 4/04; H01M 4/02; H01M 4/505; H01M 4/525; H01M 10/0525

(52) U.S. Cl. CPC H01M 4/0416; H01M 4/0471; H01M 4/505; H01M 4/525; H01M 10/0525; H01M 2004/028

(57) ABSTRACT

A manufacturing method disclosed herein includes a preparing step of preparing a collection target containing at least one of Ni and Co as a valuable metal, a heating step of heating the collection target at 500° C. or more so that at least a part of the valuable metal is reduced to a state of a metal simple substance, and an ammonia leaching step of immersing the collection target after the heating step in an ammonia aqueous solution in which ammonia, a pH buffer, and an oxidant are mixed, thereby obtaining a metal solution including the valuable metal.

### CROSS REFERENCE TO RELATED APPLICATION

This application claims the benefit of priority to Japanese Patent Application No. 2023-126803 filed on Aug. 3, 2023. The entire contents of this application are hereby incorporated herein by reference.

### BACKGROUND OF THE DISCLOSURE

### 1. Field

The art disclosed herein relates to a manufacturing method for a battery material.

### 2. Background

Lithium ion secondary batteries have been used widely in various fields. Various materials including valuable metals such as Ni and Co are used in the lithium ion secondary batteries. For example, a positive electrode plate of the lithium ion secondary battery includes a positive electrode active material and a positive electrode core body. For the positive electrode active material, for example, a lithium-transition metal complex oxide such as a lithium-nickel complex oxide, a lithium-cobalt complex oxide, a lithium-nickel-cobalt complex oxide, or a lithium-nickel-cobalt-manganese complex oxide is used. For the positive electrode core body, aluminum or the like is usually used.

In recent years, a collection technique for collecting valuable metals from used batteries, process mill ends, or the like, and reusing such valuable metals as battery materials has been advanced. Examples of the collection technique for the positive electrode plate include Japanese Patent Application Publication No. 2022-118594 and Waste Management Volume 60, February 2017 Pages 680-688.

Japanese Patent Application Publication No. 2022-118594 discloses a collection method for a valuable metal, including: a heating step of heating a battery scrap (collection target) including a positive electrode active material containing Ni and/or Co and a negative electrode active material containing graphite so as to oxidize the graphite contained in the negative electrode active material in the battery scrap and generate carbonate gas; an acid leaching step of leaching Ni and/or Co into sulfuric acid so as to generate a leachate; and a collecting step of collecting Ni and/or Co. According to Japanese Patent Application Publication No. 2022-118594, the valuable metals in the collection target (Ni ion and Co ion) are reduced to divalent oxides.

According to Waste Management Volume 60, February 2017 Pages 680-688, a positive electrode scrap is prepared by, for example, crushing a positive electrode plate and the positive electrode scrap is subjected to ammonia leaching. In this ammonia leaching, ammonia-ammonium sulfate is used as a leachate and sodium sulfite is used as a reducing agent.

### SUMMARY

As described above, in the general collecting method for valuable metals, the valuable metals are heated and leached in an acid solution such as sulfuric acid. In a case of performing an acid leaching step, the valuable metals are collected as sulfates through a neutralizing step and a solvent leaching step and by using the collected sulfates of the valuable metals, battery materials such as the positive electrode active material are manufactured as disclosed in Japanese Patent Application Publication No. 2022-118594. In such a collecting method, however, the process tends to require many steps and become complicated.

When the positive electrode active material is manufactured, an alkaline solution (in particular, ammonia water) is used. As a result of the present inventors' examination, it has been found out that by carrying out ammonia leaching at the collecting of the valuable metals (such as Ni and/or Co), the positive electrode active material can be manufactured without performing the conventional neutralizing step or solvent leaching step. On the other hand, an ammonia leaching method according to Waste Management Volume 60, February 2017 Pages 680-688 is not preferable from the viewpoint of the manufacturing efficiency because the dissolving speed of Co is particularly low and it takes 240 minutes or more to exceed a leaching rate of 80%.

The present disclosure has been made in view of the above circumstances, and an object is to provide a manufacturing method for a battery material, in which the leaching rate of a valuable metal is high and the efficiency is high.

With regard to this object, a manufacturing method for a battery material with the following structure (also referred to as “manufacturing method” simply below) is provided.

A manufacturing method for a battery material disclosed herein includes a preparing step of preparing a collection target containing at least one of Ni and Co as a valuable metal, a heating step of heating the collection target at 500° C. or more so that at least a part of the valuable metal is reduced to a state of a metal simple substance, and an ammonia leaching step of immersing the collection target after the heating step in an ammonia aqueous solution in which ammonia, a pH buffer, and an oxidant are mixed, thereby obtaining a metal solution including the valuable metal.

In the manufacturing method with the above structure, heating is performed so that at least a part of the valuable metal is reduced to the state of the metal simple substance. Therefore, in the ammonia leaching step, time reduction and a high leaching rate can be achieved. Additionally, since an acid leaching step is not performed in the manufacturing method with the above structure, a step such as a neutralizing step can be omitted. Accordingly, by this structure, the manufacturing method for the battery material, in which the leaching rate of the valuable metal is high and the efficiency is high is achieved.

### BRIEF DESCRIPTION OF THE DRAWINGS

FIG. 1 is a longitudinal cross-sectional view schematically illustrating an internal structure of a lithium ion secondary battery;

FIG. 2 is a perspective view schematically illustrating an electrode body of the lithium ion secondary battery illustrated in FIG. 1;

FIG. 3 is a flowchart for describing a manufacturing method for a battery material according to one embodiment;

FIG. 4 is a flowchart for describing a heating step in the manufacturing method according to one embodiment in detail;

FIG. 5 is a flowchart for describing an ammonia leaching step in the manufacturing method according to one embodiment in detail; and

FIG. 6 is a diagram expressing a result of XRD analysis in Example 5.

### DETAILED DESCRIPTION OF THE PREFERRED EMBODIMENTS

Embodiments of the art disclosed herein will hereinafter be described with reference to the drawings. Matters that are other than the matters particularly mentioned in the present specification and that are necessary for the implementation of the art disclosed herein can be grasped as design matters of those skilled in the art based on the prior art in the relevant field. The art disclosed herein can be implemented on the basis of the contents disclosed in the present specification and common technical knowledge in the relevant field.

### 1. Collection Target

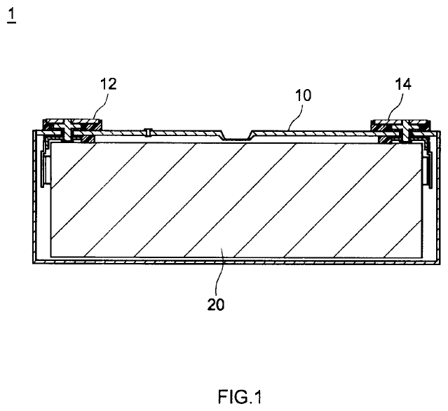

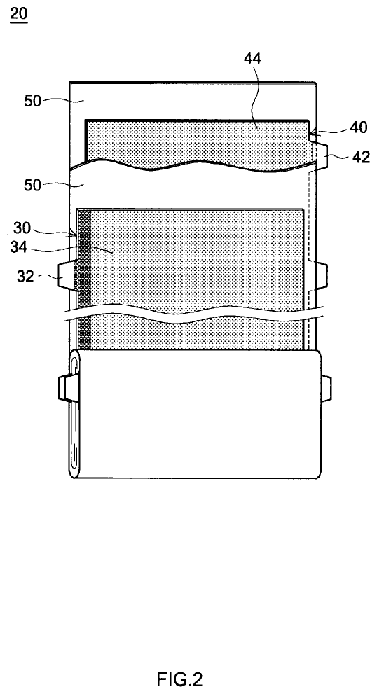

In a manufacturing method for a battery material according to this embodiment, battery materials (typically, a material of a positive electrode active material of a lithium ion secondary battery, a precursor of the positive electrode active material, and the positive electrode active material) are manufactured by collecting valuable metals such as Ni and Co from a predetermined collection target. One example of the collection target here is a used lithium ion secondary battery. This lithium ion secondary battery is specifically described below. FIG. 1 is a longitudinal cross-sectional view schematically illustrating an internal structure of the lithium ion secondary battery. FIG. 2 is a perspective view schematically illustrating an electrode body of the lithium ion secondary battery illustrated in FIG. 1.

As illustrated in FIG. 1, a lithium ion secondary battery 1 includes a case 10, an electrode body 20, and an electrolyte (not illustrated).

### (1) Case

The case 10 is a box-shaped container. This case 10 internally accommodates the electrode body 20 and the electrolyte. The case 10 is formed of, for example, a metal material with a certain strength (such as aluminum (Al)). In addition, a positive electrode terminal 12 and a negative electrode terminal 14 are attached to the case 10. The positive electrode terminal 12 and the negative electrode terminal 14 are connected to the electrode body 20 inside the case 10. Specifically, the positive electrode terminal 12 is connected to a positive electrode plate 30 (see FIG. 2) of the electrode body 20. This positive electrode terminal 12 is formed of aluminum (Al) or the like. On the other hand, the negative electrode terminal 14 is connected to a negative electrode plate 40 (see FIG. 2) of the electrode body 20. This negative electrode terminal 14 is formed of copper (Cu) or the like.

### (2) Electrode Body

The electrode body 20 is an electrical energy generation element of the lithium ion secondary battery 1. As illustrated in FIG. 2, the electrode body 20 includes the positive electrode plate 30, the negative electrode plate 40, and a separator 50. Note that the electrode body 20 illustrated in FIG. 2 is a wound electrode body here. This wound electrode body is manufactured by forming a long multilayer body with a band shape in which the positive electrode plate 30, the negative electrode plate 40, and the separator 50 are stacked, and winding the multilayer body. However, the structure of the electrode body 20 is not limited in particular and may be another conventionally known structure (such as a multilayer type electrode body).

The positive electrode plate 30 includes a positive electrode core body 32, which is a metal foil with electrical conductivity, and a positive electrode active material layer 34 provided on a surface of the positive electrode core body 32. The positive electrode core body 32 is formed of aluminum (Al) or the like. The positive electrode active material layer 34 is a mixture layer including the positive electrode active material, the conductive material, the binder, and the like. The positive electrode active material is a lithium-transition metal complex oxide containing at least one of nickel (Ni) and cobalt (Co). Examples of such a lithium-transition metal complex oxide include a lithium-nickel complex oxide, a lithium-cobalt complex oxide, a lithium-nickel-manganese complex oxide, a lithium-manganese-cobalt complex oxide, a lithium-nickel-cobalt complex oxide, a lithium-nickel-manganese-cobalt complex oxide, and the like. By the manufacturing method according to this embodiment, Ni and/or Co can be collected efficiently from a collection target containing such a lithium-transition metal complex oxide. Examples of the conductive material include carbon materials such as acetylene black and graphite. Examples of the binder include a resin material such as polyvinylidene fluoride (PVdF).

The negative electrode plate 40 includes a negative electrode core body 42, which is a metal foil with electrical conductivity, and a negative electrode active material layer 44 provided on a surface of the negative electrode core body 42. The negative electrode core body 42 is formed of copper (Cu) or the like. The negative electrode active material layer 44 is a mixture layer including the negative electrode active material, the binder, a thickener, and the like. Examples of the negative electrode active material include carbon materials such as graphite, hard carbon, and soft carbon. Other examples of the negative electrode active material include lithium titanate (LTO), silicon carbide, a complex containing carbon and silicon, silicon oxide (SiOₓ), and the like. By the manufacturing method according to this embodiment, the collection efficiency for valuable metals can be improved suitably even when the battery using the negative electrode active material based on non-carbon materials as described above is the collection target, which will be described below in detail. Examples of the binder include a resin material such as styrene butadiene rubber (SBR). Examples of the thickener include a resin material such as carboxymethyl cellulose.

The separator 50 is an insulating sheet held between the positive electrode plate 30 and the negative electrode plate 40. For this separator 50, for example, a resin material such as polyethylene (PE), polypropylene (PP), polyester, cellulose, or polyamide is used. On a surface of the separator 50, a heat-resistant layer including inorganic filler may be formed. Examples of the inorganic filler include inorganic oxides such as aluminum oxide, magnesium oxide, silicon oxide, and titanium oxide, nitrides such as aluminum nitride and silicon nitride, metal hydroxides such as calcium hydroxide, magnesium hydroxide, and aluminum hydroxide, clay minerals such as mica, talc, boehmite, zeolite, apatite, and kaolin, and the like.

### (3) Electrolyte

The electrolyte exists between the positive electrode plate 30 and the negative electrode plate 40. Thus, charge carriers (Li ions) can be transferred between the positive electrode plate 30 and the negative electrode plate 40. Examples of the electrolyte include a nonaqueous electrolyte solution, a gel electrolyte, and the like. Note that electrolytes that can be used for the lithium ion secondary battery can be used as the electrolyte without particular limitations, and the art disclosed herein is not limited thereby.

Thus, the lithium ion secondary battery 1 has been described above as one example of the collection target in the manufacturing method according to this embodiment. The manufacturing method disclosed herein, however, is not limited to the method in which the lithium ion secondary battery 1 with the aforementioned structure is the collection target. In another example, in a manufacturing site for the lithium ion secondary battery, a part of the positive electrode plate may be cut when the electrode body is manufactured. This cut part of the positive electrode plate (process mill end) can be the collection target in the manufacturing method disclosed herein because of the possibility of containing Ni or Co. In addition, in the manufacturing site for the lithium ion secondary battery, the product may become unusable due to some defect occurring in the manufactured electrode body. Such an electrode body can be the collection target because of the possibility of containing Ni or Co. That is to say, the collection target in the manufacturing method disclosed herein only needs to contain at least one of Ni and Co and is not limited particularly to a specific structure.

### 2. Manufacturing Method for Battery Material

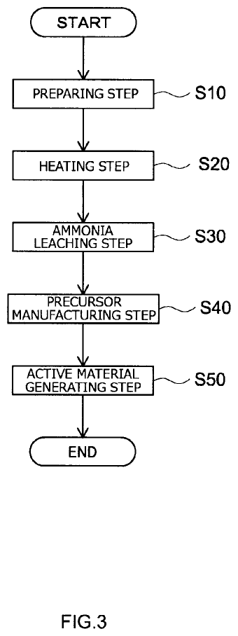

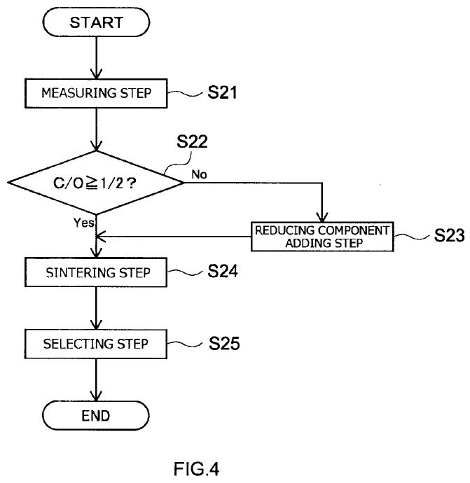

A manufacturing method for a battery material according to this embodiment is described below. FIG. 3 is a flowchart for describing the manufacturing method according to this embodiment. FIG. 4 is a flowchart for describing a heating step in FIG. 3 in detail.

As illustrated in FIG. 3, the manufacturing method for the battery material according to this embodiment includes a preparing step S10, a heating step S20, and an ammonia leaching step S30. The manufacturing method for a battery material disclosed herein may further include a precursor manufacturing step S40 and an active material generating step S50. Each step will be described below.

### (1) Preparing Step S10

In the preparing step S10, the collection target containing at least one of Ni and Co as the valuable metal is prepared. As described above, the collection target in the art disclosed herein only needs to contain at least one of Ni and Co as the valuable metal. That is to say, the collection target is not limited to the completed lithium ion secondary battery and encompasses the process mill ends and defective components (electrode body, for example). Note that since the details of the collection target are already described, the overlapping description is omitted.

### (2) Heating Step S20

In the heating step S20, the prepared collection target is heated at 500° C. or more. In the collection target prepared in the preparing step S10, the valuable metal (Ni, Co) exists as a divalent or trivalent metal ion. By heating at 500° C. or more at minimum in the heating step S20, at least a part of the valuable metal can be reduced suitably to a state of a metal simple substance (metal Ni, metal Co). Accordingly, the collection efficiency of the valuable metal (Ni and/or Co) in the ammonia leaching step S30, which will be described below, can be improved.

In the heating step S20, in the case where the collection target contains Ni, it is preferable to heat at 500° C. or more so that at least a part of Ni is reduced to the state of metal Ni. In addition, in the heating step S20, in the case where the collection target contains Co, it is preferable to heat at 500° C. or more so that at least a part of Co is reduced to the state of metal Co. In the heating step S20, in the case where the collection target contains both Ni and Co, it is preferable to heat at 500° C. or more so that at least a part of Ni and Co is reduced to the state of metal Ni and metal Co. Note that in the manufacturing method disclosed herein, it is only necessary that a part of the valuable metal is reduced to the state of the metal simple substance and another part may exist in a state of an oxide in the collection target after sintering.

In the heating step S20, by heating the prepared collection target, a liquid component in the collection target (for example, electrolyte solution) can be removed and additionally, a resin component (for example, binder and separator) can be carbonized. In the case where the charged lithium ion secondary battery 1 is the collection target, the function as a battery can be stopped by performing the heating step S20. Thus, the subsequent steps can be carried out safely. Although there is no particular limitation, the heating step S20 may include a measuring step S21, a determining step S22, a reducing component adding step S23, a sintering step S24, and a selecting step S25 as illustrated in FIG. 4. Specific description will be made below.

### (a) Measuring Step S21

In the measuring step S21, the amount of substance of each of the reducing component and an oxygen element (O) in the collection target is measured. In the measuring step S21, a part of the collection target may be extracted as a measurement sample and the oxygen element and the reducing component in the measurement sample may be measured. Moreover, the measuring step S21 may be performed only in a case where the kind of collection target is changed and does not have to be performed on all the prepared collection targets. In this manner, the manufacturing efficiency can be improved.

Note that the term “reducing component” in this specification is not limited in particular as long as the reducing component can reduce Ni and Co in the sintering step S24 to be described below. In the manufacturing method disclosed herein, a carbon element (C) can be preferably employed as the reducing component. Carbon can be employed as the reducing component particularly preferably from the viewpoint of being resistant against oxidation and stable until the sintering step S14 is started. Depending on the kind of collection target, various carbon materials (conductive material, binder, negative electrode active material, and the like) may be contained. By using these carbon materials as a supply source for the reducing component, the cost required to collect the valuable metal can be reduced.

A means that measures the amount of substance of the reducing component (carbon element) in the collection target is not limited in particular and a conventionally known measuring means can be used without particular limitations. Examples of the means that measures the amount of substance of the carbon element include thermogravimetry-differential thermal analysis (TG-DTA), SEM-EDS analysis, an oxygen stream combustion-non-dispersive infrared analysis method, a combustion gasometric method, and the like.

Next, a means that measures the amount of substance of the oxygen element in the collection target is described. First, in a case where the chemical composition of the positive electrode active material in the collection target is already grasped, the amount of substance of the metal element in the collection target is preferably measured and based on the amount of substance of the metal element, the amount of substance of the oxygen element is preferably calculated. Thus, the amount of substance of the oxygen element in valuable metal oxide (for example, lithium-transition metal complex oxide) can be measured easily. A specific example of such a measurement procedure is as follows. First, a solution in which a part of the collection target (measurement sample) is dissolved in acid is prepared. Next, this solution is subjected to inductively coupled plasma (ICP) analysis. Thus, the total amount of substance of the transition metal elements (Ni, Co, and Mn), which is M, in the collection target can be measured. If the chemical composition (LiNiₓCo_{y}Mn_{z}O_{δ}) of the positive electrode active material in the collection target is already grasped, the ratio (x+y+z:δ) between the total amount of substance of the transition metal elements (x+y+z) and the amount of substance of O (δ) can be obtained. In this case, the amount of substance of the oxygen element, which is N, can be calculated from the measurement result of ICP (total amount of substance of the metal elements, M) in accordance with the following Formula (1):

$$N = δ \cdot M / ( x + y + z ) \qquad ( 1 )$$

Note that the means that measures the amount of substance of the oxygen element in the collection target is not limited to the aforementioned means and a conventionally known measuring means can be used without particular limitations. For example, the oxygen element in the collection target may be measured directly using the SEM-EDS analysis, XRF analysis, or the like. By using these methods, the amount of substance of the oxygen element can be measured even when the chemical composition of the positive electrode active material in the collection target is unknown.

### (b) Determining Step S22

In the determining step S22, it is determined whether the ratio of the amount of substance of the reducing component to that of the oxygen element is more than or equal to a predetermined threshold. Here, the threshold in this step is set based on the stoichiometric ratio of an oxide of the reducing component. For example, in the case of using the carbon element (C) as the reducing component, the oxide of the reducing component is carbon dioxide (CO₂). At this time, in the sintering step S24 to be described below, it is preferable that the threshold be more than or equal to the ratio (1/2) of the carbon element to the oxygen element in CO₂ in order to reduce at least a part of the valuable metal (Ni, Co) suitably to the state of the metal simple substance (metal Ni, metal Co). In the determining step S22, it is determined whether the ratio (also referred to as “C/O ratio” below) of the amount of substance of the carbon element (reducing component) to the oxygen element in the collection target is 1/2 or more. If the C/O ratio is 1/2 or more (YES in S22 in FIG. 4), the process advances to the sintering step S24. On the other hand, if the C/O ratio is less than 1/2 (NO in S22 in FIG. 4), the process preferably advances to the reducing component adding step S23. Thus, the valuable metal can be reduced to the state of the metal simple substance more suitably.

Note that, as described above, the threshold in the determining step S22 may be set at a value more than or equal to the stoichiometric ratio of the oxide of the reducing component. For example, in the case where the reducing component is the carbon element, the threshold may be set to 3/4 or more (more preferably 1 or more, still more preferably 5/4 or more, and particularly preferably 3/2 or more). Thus, only the collection target containing the reducing component (carbon element) in a large quantity can be supplied to the sintering step S24. Accordingly, the reduction of the valuable metal oxide in the sintering step S24 can be promoted further and most part of the valuable metal can be made into the metal simple substance.

### (c) Reducing Component Adding Step S23

The reducing component adding step S23 is preferably performed in the case where the determination result in the determining step S22 is less than the threshold (NO in S22 in FIG. 4). In the reducing component adding step S23, the reducing component is added to the collection target. For example, it is preferable to add the reducing component (carbon-containing material) to the collection target whose C/O ratio has been determined to be less than 1/2 in the determining step S22 so that this C/O ratio becomes more than or equal to the threshold (1/2 or more). Thus, the valuable metal can be reduced more suitably to the state of the metal simple substance. Here, as the carbon-containing material, a carbon material such as graphite, hard carbon, or soft carbon is given. The carbon-containing material may alternatively be a resin material such as polyolefin or polyester. These resin materials generate the carbon element by carbonization in the initial stage of the sintering step S24 and accordingly are usable as a supply source for the carbon element.

Note that in the reducing component adding step S23, the reducing component may be added in a quantity far more than the threshold described above. For example, in the case where the reducing component is the carbon element, the carbon-containing material may be added so that the C/O ratio in the collection target becomes 3/4 or more (more preferably 1 or more, still more preferably 5/4 or more, and particularly preferably 3/2 or more). Thus, the collection target containing the reducing component (carbon element) in a large quantity can be supplied to the sintering step S24; therefore, the reduction of the valuable metal oxide in the sintering step S24 can be promoted further.

### (d) Sintering Step S24

In the sintering step S24, the collection target is sintered (heated) at 500° C. or more. Thus, at least a part of the valuable metal (Ni and/or Co) can be reduced to the state of the metal simple substance and the collection rate of the valuable metal can be improved suitably. For example, in the case of sintering the collection target at 500° C. or more in the sintering step S24, the reaction as expressed in the following Formula (2) can occur. Thus, at least a part of the valuable metal (for example, Ni, Co) in the collection target can be reduced to the state of the metal simple substance (metal Ni, metal Co).

$${LiNi}_{x} {Co}_{y} {Mn}_{z} {O}_{δ} + {C}_{1 / 2 δ} = Li + xNi + yCo + zMn + 1 / 2 δ \cdot {CO}_{2} \qquad ( 2 )$$

It is only necessary that the heating temperature in the sintering step S24 (more specifically, the temperature in a heating furnace) is 500° C. or more. As the heating temperature increases, the metal simple substance of the valuable metal tends to be generated more easily. As described above, in the manufacturing method disclosed herein, it is only necessary that at least a part of the valuable metal is reduced to the state of the metal simple substance. In order to dissolve the valuable metal more efficiently in the ammonia leaching step S30 to be described below, it is preferable that most part of the valuable metal be reduced to the state of the metal simple substance. From such a viewpoint, the heating temperature is preferably 650° C. or more, and may be 700° C. or more or 750° C. or more. On the other hand, from the viewpoint of reducing the valuable metal, the upper limit of the heating temperature is not limited in particular and may be 1500° C. or less, 1400° C. or less, or 1300° C. or less. In consideration of the cost reduction for the sintering step S24, for example, the upper limit of the heating temperature is preferably 1200° C. or less, more preferably 1100° C. or less, and particularly preferably 1000° C. or less. Since the sintering time in the sintering step S24 is different depending on the amount of collection target and the like, the sintering time is not defined generally. The sintering time in the sintering step S24 is preferably 1 to 12 hours and more preferably 2 to 8 hours, for example.

Although there is no particular limitation, it is preferable to heat the collection target in an inert atmosphere in the sintering step S24. In this case, the supply of the oxygen element to the collection target during the heating can be prevented and at least a part of the valuable metal oxide (such as lithium-transition metal complex oxide) can be reduced more suitably to the state of the metal simple substance. Specifically, in the sintering step S24, it is preferable to heat the collection target while feeding an inert gas such as argon or nitrogen. Note that the term “inert atmosphere” in this specification refers to a heating atmosphere mainly containing the aforementioned inert gas. That is to say, the inert atmosphere is not limited to a perfectly inert atmosphere in which the content of the inert gas is 100% (the content of the oxygen element is 0%) and includes a heating atmosphere in which the content of the oxygen element is 5% or less (preferably 3% or less, more preferably 1% or less, still more preferably 0.5% or less, and particularly preferably 0.1% or less).

Although there is no particular limitation, it is preferable to perform the sintering in the sintering step S24 so that the metal simple substance of the valuable metal becomes dominant over the oxide of the valuable metal in the valuable metal. The state of the valuable metal can be checked by, for example, X-ray diffraction (XRD) analysis. Therefore, in the XRD analysis regarding the valuable metal, in a case where the ratio of a peak derived from the metal simple substance of the valuable metal to a peak derived from the oxide of the valuable metal is 1 or more, it can be said that the metal simple substance of the valuable metal is dominant over the oxide of the valuable metal in the valuable metal. Specifically, for example, in the case of Ni, a peak of Ni oxide (NiO) is observed at around 19° and a peak of metal Ni is observed at around 20° in the X-ray diffraction using a Mo line source. When the ratio of the peak derived from metal Ni to the peak derived from Ni oxide (metal Ni/Ni oxide) is 1 or more, metal Ni is dominant over Ni oxide.

### (e) Selecting Step S25

In the selecting step S25, members included in the collection target after the sintering (heating) are selected with a sieve. For example, in the case where the process mill ends of the positive electrode plate 30 are the collection target, the positive electrode core body 32 is preferably selected from the process mill ends with a sieve and removed from the collection target. In the case where the electrode body 20 is the collection target, the negative electrode plate 40 is preferably removed from the collection target in addition to the positive electrode core body 32. Moreover, in the case where the lithium ion secondary battery 1 is the collection target, the case 10 is also preferably removed from the collection target in addition to the positive electrode core body 32 and the negative electrode plate 40. Thus, the content of other metal components (such as Al and Cu) in the collection target is reduced and accordingly, the collection efficiency of the valuable metal (Co, Ni) can be improved.

In the selecting step S25, the collection target may be crushed as necessary. In this case, the efficiency in selecting the members can be improved. For example, in the case where the lithium ion secondary battery 1 is the collection target, the case 10 and the electrode body 20 are preferably crushed. This makes it easier to remove the case 10, the positive electrode core body 32, and the negative electrode plate 40 from the collection target.

The selecting step S25 is not the step intended to remove the other metal components such as Al completely from the collection target. Even in the case where the other metal components remain in the collection target, the valuable metal (Ni and/or Co) and the other metal components can be separated from each other sufficiently in the subsequent step (ammonia leaching step S30), which will be described in detail below. That is to say, this step can be suitably omitted as necessary. In the case where, for example, the content of the other metal components is low in the collection target (for example, the process mill ends of the positive electrode plate 30), the valuable metal can be collected efficiently without this step.

### (3) Ammonia Leaching Step S30

In the ammonia leaching step S30, the collection target after the heating step S20 is immersed in an ammonia aqueous solution. Thus, a metal solution in which the valuable metal (Ni and/or Co) in the collection target is dissolved in the ammonia aqueous solution can be obtained. In the manufacturing method disclosed herein, a mixture of ammonia, a pH buffer, and an oxidant is used as the ammonia aqueous solution. The collection target after the heating step S20 can contain, in addition to the aforementioned valuable metal component, Li derived from the positive electrode active material, Al derived from the positive electrode core body 32 and the case 10, and the like. For example, Al is not easily dissolved in the ammonia aqueous solution and therefore remains as a solid content. In the manufacturing method disclosed herein, the heating step S20 is performed so that at least a part of the valuable metal becomes the metal simple substance. Thus, in the ammonia leaching step S30, a high leaching rate can be achieved in a shorter time than before. That is to say, by performing the ammonia leaching step S30 on the valuable metal, at least a part of which has become the metal simple substance in the heating step S20, the valuable metal (Ni and/or Co) corresponding to the collection target and the other metal components (for example, Al and the like) can be separated from each other easily. Although there is no particular limitation, the ammonia leaching step S30 can include a preparation step S31 and an immersion step S32 as illustrated in FIG. 5. Specific description is made below.

### (a) Preparation Step S31

In the preparation step S31, the ammonia aqueous solution is prepared by mixing ammonia, the pH buffer, and the oxidant. The pH of the ammonia aqueous solution is preferably 8.0 to 11.0 and more preferably 9.0 to 10.0. The concentration of ammonia in the ammonia aqueous solution is preferably 5 wt % to 35 wt %, and more preferably 15 wt % to 30 wt %. Thus, the valuable metal can be dissolved suitably.

The pH buffer is a compound with a function of keeping the pH of the solution at a predetermined value even if an acid or a base is added to a certain degree. In other words, the pH buffer can control the pH of the ammonia aqueous solution to be 11 or less, for example. When the ammonia aqueous solution contains the pH buffer, the concentration of ammonia can be set within the aforementioned range with the pH of the ammonia aqueous solution not exceeding 11. Thus, the valuable metal can be dissolved suitably. The pH buffer is not limited in particular as long as the pH buffering property can be achieved in the ammonia aqueous solution. Examples of the pH buffer include ammonium salt, amino acid, organic acid salt, boric acid salt, an amine compound, and the like. As the pH buffer, one kind can be used alone or two or more kinds can be used in combination. In particular, the ammonium salt is preferable. Specific examples of the ammonium salt include ammonium sulfate, ammonium chloride, ammonium carbonate, ammonium nitrate, and the like. The pH buffer is more preferably ammonium sulfate or ammonium chloride.

Although there is no particular limitation, the concentration of the pH buffer in the ammonia aqueous solution is preferably 0.5 mol/L or more, and may be 1 mol/L or more or 2 mol/L or more. Thus, the excellent pH buffering property can be achieved. Although there is no particular limitation, the upper limit of the concentration of the pH buffer may be 5 mol/L or less or 4.5 mol/L or less, for example. Thus, for example, the consumption of a reagent in the precursor manufacturing step S40 to be described below can be reduced.

The oxidant is a compound that oxidizes another material. In the manufacturing method disclosed herein, at least a part of the valuable metal is reduced to the state of the metal simple substance in the heating step S20. Specifically, Co and Ni are present in the sintered collection target as a state less than or equal to a divalent state, more preferably as metal Co and metal Ni. In order to dissolve such Co and/or Ni as the metal ion in the ammonia aqueous solution, it is necessary the increase the valence. For this reason, the ammonia aqueous solution contains the oxidant in the manufacturing method disclosed herein. The oxidant is not limited in particular as long as the oxidant can oxidize the valuable metal. Examples of the oxidant include a peroxide, a permanganate and a salt thereof, a nitric acid and a salt thereof, and the like. As the oxidant, one kind can be used alone or two or more kinds can be used in combination. In particular, as the oxidant, hydrogen peroxide, potassium permanganate, nitric acid, potassium nitrate, sodium peroxide, or manganese oxide can be preferably used.

Although there is no particular limitation, the concentration of the oxidant in the ammonia aqueous solution is preferably 0.1 mol/L or more and more preferably 0.5 mol/L or more. Thus, the excellent valuable metal can be oxidized suitably. Although there is no particular limitation, the upper limit of the concentration of the oxidant may be 3 mol/L or less or 2 mol/L or less, for example.

### (b) Immersion Step S32

In the immersion step S32, the collection target after the heating step S20 is immersed in the prepared ammonia aqueous solution. As described above, by making at least a part of the valuable metal the metal simple substance, the solubility in the ammonia aqueous solution is improved. Therefore, in the manufacturing method disclosed herein, the high leaching rate can be achieved in a shorter time than before. Since Al and the like in the collection target do not dissolve easily in the ammonia aqueous solution, only the intended valuable metal (here, Ni and Co) can be dissolved in the ammonia aqueous solution selectively.

The immersion time in the immersion step S32 is preferably 10 minutes or more, more preferably 30 minutes or more, still more preferably 60 minutes or more, and particularly preferably 110 minutes or more. Thus, Ni and/or Co in the collection target can be dissolved sufficiently in the ammonia aqueous solution. In the manufacturing method disclosed herein, when the immersion time is more than 120 minutes, substantially all Ni and/or Co in the collection target can be dissolved in the ammonia aqueous solution. Therefore, in consideration of the manufacturing efficiency, the upper limit of the immersion time is preferably 180 minutes or less and more preferably 150 minutes or less.

The temperature of the ammonia aqueous solution in the immersion step S32 is not limited in particular. For example, the temperature of the ammonia aqueous solution is preferably 50° C. or more (more preferably 55° C. or more and particularly preferably 60° C. or more). Thus, the ammonia leaching step S30 can be shortened. The upper limit value of the temperature of the ammonia aqueous solution is not limited in particular and may be 90° C. or less, 85° C. or less, or 80° C. or less. Although there is no particular limitation, the immersion step S32 is preferably performed while stirring.

As described above, in the manufacturing method disclosed herein, by making at least a part of the valuable metal the metal simple substance in the heating step S20, the valuable metal can be dissolved in the ammonia aqueous solution suitably. In the conventional method, Co and Ni are collected as the sulfates by performing an acid leaching step, a neutralizing step, a cleaning step, and a solvent extracting step after the heating step. On the other hand, in the manufacturing method disclosed herein, Co and Ni can be separated from the other metal components just by performing the ammonia leaching step S30 after the heating step S20. Since the acid leaching step is not performed in the manufacturing method disclosed herein, the neutralizing step is not required. Moreover, since the separated Ni and Co exist in the ammonia aqueous solution, the step of manufacturing the positive electrode active material precursor (precursor manufacturing step S40) can be performed using the solution continuously. That is to say, by the manufacturing method disclosed herein, the number of steps can be reduced drastically after the heating step S20 is completed and before the precursor manufacturing step S40 is started, while achieving the high leaching rate of the valuable metal.

### (4) Precursor Manufacturing Step S40

In the precursor manufacturing step S40, the positive electrode active material precursor (metal complex hydroxide) is precipitated using the metal solution obtained in the ammonia leaching step S30. In general, in the step of manufacturing the precursor of the positive electrode active material, an alkali solution (specifically, ammonia water) is dropped in a solution in which a metal sulfate is dissolved and the solution is stirred while the pH is controlled; thus, particles of the metal complex hydroxide are co-precipitated in a reaction tank and crystallized. In the metal solution after the ammonia leaching step S30, Ni and/or Co is contained in the ammonia aqueous solution in a mode of an ammine complex. Therefore, the metal solution obtained in the ammonia leaching step S30 can be used continuously in the precursor manufacturing step S40. By stirring the metal solution while adjusting the pH thereof, the positive electrode active material precursor (metal complex hydroxide) can be crystallized.

In the precursor manufacturing step S40, the pH of the metal solution can be controlled to be about 9 to 13. In the precursor manufacturing step S40, the metal solution is preferably stirred while an alkali solution (for example, sodium hydroxide or sodium carbonate) is added as necessary so as to control the pH. The amount of Ni and Co in the metal solution obtained in the ammonia leaching step S30 can be obtained by ICP analysis. Therefore, Ni, Co, or another metal element such as Mn may be added in accordance with the composition of the intended positive electrode active material. Such a metal component can be added in a mode of a sulfate, a hydrate, or the like of the metal.

### (5) Active Material Generating Step S50

In the active material generating step S50, the battery material (positive electrode active material) is generated using the positive electrode active material precursor (metal complex hydroxide) obtained in the precursor manufacturing step S40 and a Li compound (for example, Li carbonate). For example, the Li compound and the positive electrode active material precursor prepared as above are mixed, and this mixture is sintered. Thus, the positive electrode active material (lithium-transition metal complex oxide) of the lithium ion secondary battery can be manufactured.

The manufacturing method for the battery material according to this embodiment has been described above. In the manufacturing method according to this embodiment, as described above, the heating step S20 is performed by heating the collection target at 500° C. or more so that a part of the valuable metal in the collection target becomes the metal simple substance. Thus, the valuable metal (Ni and/or Co) is dissolved suitably in the ammonia aqueous solution in the ammonia leaching step S30. Thus, even if the time of the leaching step is short, the collection rate of the valuable metal can be improved. In addition, since the acid leaching step that is performed in the conventional method is omitted in the manufacturing method disclosed herein, the precursor of the positive electrode active material can be manufactured without requiring the neutralizing step or the solvent extracting step. By such a manufacturing method, the manufacturing process can be drastically shortened while the collection rate of the valuable metal is improved.

### 3. Other Embodiments

One embodiment of the art disclosed herein has been described above. Note that the art disclosed herein is not limited to the aforementioned embodiment and includes other embodiments with various structures changed. Other examples of the embodiment of the art disclosed herein will be disclosed below.

In the manufacturing method according to the above-described embodiment, Ni and/or Co is collected as the valuable metal. In the manufacturing method disclosed herein, however, lithium (Li) can be collected (manufactured) as necessary in addition to nickel (Ni) and cobalt (Co) described above. That is to say, the description about the aforementioned embodiment does not intend to limit each step. In the manufacturing method disclosed herein, each step may be suitably added, deleted, or changed as necessary.

As one example of a means that collects Li, the following means is given. First, when the heating step S20 is performed, a chloridizing roasting step of adding a non-metal chlorine compound (such as HCl) to the collection target and roasting the obtained collection target is performed. Thus, Li in the collection target reacts with the non-metal chlorine compound and LiCl is generated. Next, a water leaching step of immersing the roasted collection target in water is performed. Since LiCl is a water-soluble compound, Li can be collected just by bringing the collection target in contact with water.

The detailed conditions in the heating step S20 may be changed as appropriate. For example, in the manufacturing method according to the aforementioned embodiment, the carbon element is used as the reducing component. However, as described above, the reducing component is not limited in particular as long as the reducing component can reduce Ni and Co in the sintering step S24. As the reducing component other than the carbon element (C), metal-based reducing components such as lithium (Li), cesium (Cs), potassium (K), barium (Ba), strontium (Sr), calcium (Ca), sodium (Na), magnesium (Mg), aluminum (Al), titanium (Ti), zirconium (Zr), and manganese (Mn) are given. These metal-based reducing components are preferably present in the collection target in a state of a sulfite or the like. For example, in the case of using calcium sulfite (CaSO₃) as the reducing component, at least a part of the valuable metal is reduced to the metal simple substance and calcium oxide (CaO) is generated in the heating step S20. In this case, the threshold in the determining step S22 is set to a value more than or equal to the stoichiometric ratio (1/1) of CaO. Thus, the valuable metal in the collection target can be reduced suitably to the state of the metal simple substance. As a means that measures the metal-based reducing component in the measuring step S21, ICP, SEM-EDS analysis, XRF analysis, or the like is given. The reducing component to be determined in the determining step S22 and the reducing component to be added in the reducing component adding step S23 may be either the same or different. For example, if it is determined that the carbon element (C) is deficient in the determining step S22, calcium sulfite (CaSO₃) may be added in the reducing component adding step S23. Even in this case, the valuable metal can be reduced as appropriate to the state of the metal simple substance in the sintering step S24.

### Test Examples

Test Examples regarding the art disclosed herein will be described below. The contents of Test Examples given below do not intend to limit the art disclosed herein.

### 1. Preparation of Sample

(Example 1) In this test, the positive electrode plate was the collection target and a test sample was prepared for the collection target in accordance with the following procedure. First, the positive electrode plate corresponding to the collection target was prepared. As the positive electrode plate, the positive electrode core body (Al foil) having the positive electrode active material layer applied on the surface was prepared. Note that as the positive electrode active material in this test, a lithium-nickel-cobalt-manganese complex oxide (LiNi_{1/3}Co_{1/3}Mn_{1/3}O₂) was prepared. Then, the positive electrode plate was crushed and by using a sieve with an opening size of 500 μm, a powder body was prepared.

Next, a part of the prepared powder body was extracted and dissolved in sulfuric acid. Then, the solution was subjected to ICP and the total amount of substance of Ni, Co, and Mn, which is M, was measured. Based on the composition of the positive electrode active material (LiNi_{1/3}Co_{1/3}Mn_{1/3}O₂), the amount of substance that is twice the total amount of substance, M, was defined as the amount of substance of the oxygen element, N (N=2M). In this test, the thermogravimetry-differential thermal analysis (TG-DTA) was performed on a part of the prepared powder body. In this thermogravimetry-differential thermal analysis, the powder body was heated in an air atmosphere of 800° C. Note that in this analysis, the temperature rising speed was set to 5° C./min from room temperature (20° C.) to 800° C. Thus, the amount of carbon in the prepared powder body was measured. Then, graphite was additionally mixed in the powder body so that the ratio (C/O ratio) of the amount of substance of the carbon element to that of the oxygen element that were measured became more than or equal to the stoichiometric ratio of CO₂ (1/2). Thus, a sample according to Example 1 was prepared.

Next, the test sample was heated in the inert atmosphere. Specifically, in Example 1, the test sample was accommodated in an electric furnace, and while Ar gas was supplied, the temperature in the furnace was increased to 150° C. At this time, the temperature rising speed was set to 5° C./min. While the temperature in the furnace was kept at 150° C., the heating was conducted for five hours. After that, the temperature in the furnace was reduced to 50° C. and then, the sample according to Example 1 was collected.

The collected sample was subjected to ammonia leaching. Specifically, first, 28 wt % of ammonia (NH₃), 2 mol/L of ammonium sulfate ((NH₄)₂SO₄) as the pH buffer, and 0.5 mol/L of hydrogen peroxide (H₂O₂) as the oxidant were mixed to prepare the ammonia aqueous solution. Next, the sample after the heating was input to the ammonia aqueous solution. While the temperature of the ammonia aqueous solution was kept at 80° C., a stirring process with a stirring speed of 500 rpm was continued for two hours.

### Example 2 to Example 7

In Example 2 to Example 7, the temperature in the furnace was changed as shown in Table 1. Except this change, the process similar to that in Example 1 was performed and samples according to Example 2 to Example 7 were obtained. Then, the samples according to Example 2 to Example 7 were subjected to ammonia leaching.

### Example 8 and Example 9

In Example 8 and Example 9, the temperature in the furnace was changed as shown in Table 1. Except this change, the process similar to that in Example 1 was performed and samples according to Example 8 and Example 9 were obtained. Then, the concentration of the pH buffer in the samples according to Example 8 and Example 9 was changed as shown in Table 1 and ammonia leaching was performed.

### Example 10

In Example 10, graphite was not additionally mixed. The temperature in the furnace was changed as shown in Table 1. Except these things, the process similar to that in Example 1 was performed and a sample according to Example 10 was obtained. Then, the sample according to Example 10 was subjected to ammonia leaching.

### 2. Evaluation Test

### (1) XRD Analysis

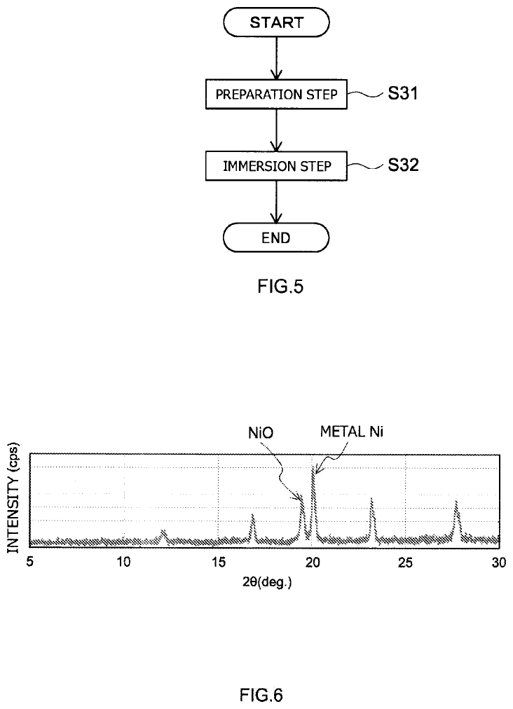

The test sample according to each example after the heating was subjected to X-ray diffraction (XRD) analysis using a Mo line source and the state of the Ni element in the test sample was evaluated. The results are shown in Table 1. Moreover, FIG. 6 shows the XRD chart in Example 5. In the case where the peak derived from the positive electrode active material is not observed at around 8° and the peaks can be observed at around 19° and 20° as shown in FIG. 6, it was evaluated that at least a part of the Ni element after the sintering became the metal simple substance (“metal oxide+metal simple substance” in Table 1). In the case where the peak derived from the positive electrode active material is not observed at around 8° and the peak can be observed only at around 20°, it was evaluated that most part of the Ni element after the sintering became the metal simple substance (“metal simple substance” in Table 1). Furthermore, in the case where the peak derived from the positive electrode active material is observed at around 8° and the peak is observed only at around 19°, it was evaluated that all the Ni element exists as the state of the oxide (“oxide” in Table 1).

Regarding the state of the Co element in the test sample, the XRD analysis was similarly performed in accordance with the same procedure as that for the state evaluation of Ni. The results are shown in Table 1.

In this test, the peak intensity ratio (metal Ni/Ni oxide) of the metal Ni peak to the Ni oxide peak was calculated in Example 3 to Example 10 in which the peak derived from the positive electrode active material is not observed at around 8°. The results are shown in Table 1. In the case where the peak intensity ratio (metal Ni/Ni oxide) is less than 1, it was evaluated that the sample in which Ni oxide was dominant was generated and in the case where the peak intensity ratio is 1 or more, it was evaluated that the sample in which metal Ni was dominant was generated.

### (2) Leaching Rate in Ammonia Leaching

The test sample according to each example after the ammonia leaching was subjected to the ICP analysis and the Ni and Co leaching rates in each example were calculated. Specifically, first, the metal solution in which the sample according to each example was dissolved was filtered. Next, the filtrate was subjected to the ICP and the amount of substance of each of Ni and Co in the filtrate was measured. In accordance with the following Formula (3), the leaching rate of each metal element was calculated. Note that “the amount of substance before the ammonia leaching” in Formula (3) is the value estimated by measuring and grasping the amount of substance per gram in accordance with the ICP analysis and multiplying the result by the weight of the sample added to ammonia.

$$Leaching rate = \qquad ( 3 )$$

$$( the amount of substance in the filtrate /$$

$$the amount of substance before the ammonia leaching ) \times 100$$

TABLE 1

| | | | Concentration | XRD analysis | | | Leaching | |
|---|---|---|---|---|---|---|---|---|
| | | Temperature | of pH buffer | | | Metal Ni/ | rate (%) | |
| | C/O ratio | (° C.) | (mol/L) | Ni | Co | Ni oxide | Ni | Co |
| Example 1 | ½ or more | 150 | 2.0 | Oxide | Oxide | — | 61 | 50 |
| Example 2 | ½ or more | 400 | 2.0 | Oxide | Oxide | — | 70 | 61 |
| Example 3 | ½ or more | 500 | 2.0 | Oxide + metal simple | Oxide + metal simple | less than 1 | 75 | 67 |
| | | | | substance | substance | | | |
| Example 4 | ½ or more | 650 | 2.0 | Oxide + metal simple | Oxide + metal simple | 1 or more | 87 | 81 |
| | | | | substance | substance | | | |
| Example 5 | ½ or more | 700 | 2.0 | Oxide + metal simple | Oxide + metal simple | 1 or more | 90 | 95 |
| | | | | substance | substance | | | |
| Example 6 | ½ or more | 750 | 2.0 | Metal simple | Metal simple | 1 or more | 90 | 86 |
| | | | | substance | substance | | | |
| Example 7 | ½ or more | 1000 | 2.0 | Metal simple | Metal simple | 1 or more | 86 | 80 |
| | | | | substance | substance | | | |
| Example 8 | ½ or more | 750 | 0.5 | Metal simple | Metal simple | 1 or more | 88 | 83 |
| | | | | substance | substance | | | |
| Example 9 | ½ or more | 750 | 0.1 | Metal simple | Metal simple | 1 or more | 71 | 69 |
| | | | | substance | substance | | | |
| Example 10 | less than ½ | 750 | 2.0 | Oxide + metal simple | Oxide + metal simple | less than 1 | 76 | 67 |
| | | | | substance | substance | | | |

Table 1 indicates that, in Example 3 to Example 10 in which the sintering temperature is 500° C. or more, at least a part of Ni became the metal simple substance and at least a part of Co became the metal simple substance. It is also indicated that by the ammonia leaching, the Ni leaching rate is 71% or more and the Co leaching rate is 67% or more. That is to say, when the collection target is heated at 500° C. or more so that at least a part of the valuable metal is reduced to the state of the metal simple substance and the heated collection target is immersed in the ammonia aqueous solution in which ammonia, the pH buffer, and the oxidant are mixed, the manufacturing method for the battery material with the high efficiency and the high leaching rate of the valuable metal can be achieved.

The art disclosed herein has been described above in detail; however, these are just examples and will not limit the scope of claims. The art described in the scope of claims includes those in which the specific examples given above are variously modified and changed. That is to say, the art disclosed herein includes modes according to the following Items 1 to 8.

<Item 1> The manufacturing method for the battery material, including: the preparing step of preparing the collection target containing at least one of Ni and Co as the valuable metal; the heating step of heating the collection target at 500° C. or more so that at least a part of the valuable metal is reduced to the state of the metal simple substance; and the ammonia leaching step of immersing the collection target after the heating step in the ammonia aqueous solution in which ammonia, the pH buffer, and the oxidant are mixed, thereby obtaining the metal solution including the valuable metal.

<Item 2> The manufacturing method for the battery material according to Item 1, in which the pH buffer has a concentration of 0.5 mol/L or more.

<Item 3> The manufacturing method for the battery material according to Item 1 or 2, in which the heating step includes the reducing component adding step of adding the reducing component so that the amount of substance of the reducing component becomes more than or equal to the threshold based on the stoichiometric ratio of the oxide of the reducing component relative to the amount of substance of the oxygen element in the collection target.

<Item 4> The manufacturing method for the battery material according to Item 3, in which the reducing component is the carbon element and the threshold is the value more than or equal to the stoichiometric ratio of CO₂.

<Item 5> The manufacturing method for the battery material according to any one of Items 1 to 4, in which the collection target is heated at 650° C. to 1000° C. in the heating step.

<Item 6> The manufacturing method for the battery material according to any one of Items 1 to 5, in which in the heating step, the sintering is performed so that the ratio of the peak derived from the metal simple substance of the valuable metal to the peak derived from the oxide of the valuable metal becomes 1 or more in the XRD analysis of the valuable metal.

<Item 7> The manufacturing method for the battery material according to any one of Items 1 to 6, further including the step of manufacturing the positive electrode active material precursor using the metal solution in the ammonia leaching step.

<Item 8> The manufacturing method for the battery material according to any one of Items 1 to 7, in which the collection target contains at least one kind selected from the group consisting of the lithium-nickel complex oxide, the lithium-cobalt complex oxide, the lithium-nickel-manganese complex oxide, the lithium-manganese-cobalt complex oxide, the lithium-nickel-cobalt complex oxide, and the lithium-nickel-manganese-cobalt complex oxide.

### REFERENCE SIGNS LIST

1 Lithium ion secondary battery
10 Case
12 Positive electrode terminal
14 Negative electrode terminal
20 Electrode body
30 Positive electrode plate
32 Positive electrode core body
34 Positive electrode active material layer
40 Negative electrode plate
42 Negative electrode core body
44 Negative electrode active material layer
50 Separator

What is claimed is:

1. A manufacturing method for a battery material, comprising:
a preparing step of preparing a collection target containing at least one of Ni and Co as a valuable metal;
a heating step of heating the collection target at 500° C. or more so that at least a part of the valuable metal is reduced to a state of a metal simple substance; and
an ammonia leaching step of immersing the collection target after the heating step in an ammonia aqueous solution in which ammonia, a pH buffer, and an oxidant are mixed, thereby obtaining a metal solution including the valuable metal.

2. The manufacturing method for a battery material according to claim 1, wherein the pH buffer has a concentration of 0.5 mol/L or more.

3. The manufacturing method for a battery material according to claim 1, wherein the heating step includes a reducing component adding step of adding a reducing component so that an amount of substance of the reducing component becomes more than or equal to a threshold based on a stoichiometric ratio of an oxide of the reducing component relative to an amount of substance of an oxygen element in the collection target.

4. The manufacturing method for a battery material according to claim 3, wherein the reducing component is a carbon element and the threshold is a value more than or equal to a stoichiometric ratio of CO₂.

5. The manufacturing method for a battery material according to claim 1, wherein the collection target is heated at 650° C. to 1000° C. in the heating step.

6. The manufacturing method for a battery material according to claim 1, wherein in the heating step, sintering is performed so that a ratio of a peak derived from the metal simple substance of the valuable metal to a peak derived from an oxide of the valuable metal becomes 1 or more in an XRD analysis of the valuable metal.

7. The manufacturing method for a battery material according to claim 1, further comprising a step of manufacturing a positive electrode active material precursor using the metal solution in the ammonia leaching step.

8. The manufacturing method for a battery material according to claim 1, wherein the collection target contains at least one kind selected from the group consisting of a lithium-nickel complex oxide, a lithium-cobalt complex oxide, a lithium-nickel-manganese complex oxide, a lithium-manganese-cobalt complex oxide, a lithium-nickel-cobalt complex oxide, and a lithium-nickel-manganese-cobalt complex oxide.
